(19) United States
(12) Patent Application Publication
(10) Pub. No.: US 2014/0222332 A1
(43) Pub. Date: Aug. 7, 2014

(54) MOBILE TERMINAL, ELECTRONIC NAVIGATIONAL CHART SERVER, AND METHOD FOR UPDATING ELECTRONIC NAVIGATIONAL CHART BASED ON CROWDSOURCING THEREOF

(71) Applicant: Electronics and Telecommunications Research Institute, Daejeon (KR)

(72) Inventors: Chung-ho LEE, Daejeon (KR); In Sung JANG, Sejong City (KR); Min Soo KIM, Sejong City (KR); Sung Woong SHIN, Daejeon (KR)

(73) Assignee: Electronics and Telecommunications Research Institute, Daejeon (KR)

(21) Appl. No.: 13/972,820

(22) Filed: Aug. 21, 2013

(30) Foreign Application Priority Data
Feb. 1, 2013 (KR) 10-2013-0011889

(51) Int. Cl. G01C 21/00

(52) U.S. Cl. CPC G01C 21/00
USPC 701/450; 707/621

(57) ABSTRACT

An electronic navigational chart updating system receives navigational chart information regarding navigation collected from mobile terminals of a plurality of information providers embarked in a plurality of vessels, and updates an electronic navigational chart by using the received navigational chart information.

### CROSS-REFERENCE TO RELATED APPLICATION

This application claims priority to and the benefit of Korean Patent Application No. 10-2013-0011889 filed in the Korean Intellectual Property Office on Feb. 1, 2013, the entire contents of which are incorporated herein by reference.

### BACKGROUND OF THE INVENTION

(a) Field of the Invention

The present invention relates to a mobile terminal, an electronic navigational chart server, and a method for updating an electronic navigational chart based on crowdsourcing thereof.

(b) Description of the Related Art

An electronic navigational chart refers to a digital map produced in conformity with the standard of the International Hydrographic Organization (IHO), including information regarding every navigational chart in relation to navigation of ships, such as coastlines, depth contours, water levels, beacons (lighthouses, light buoys), dangers, and the like, appearing on a paper navigational chart to use an electronic chart display and information system (ECDIS) or an electronic chart system (ECS).

In conformity with the standard of the IHO, vessels weighing 500 tons or more should essentially use ECDIS and small and medium class vessels use ECS. However, a small vessel, a cruise ship, a motor boat, a yacht, or the like, is not equipped with high-tech equipment, and thus, to this end, a mobile electronic navigational chart system based on a mobile device such as a smart phone, or the like, has been developed and utilized.

Situations on the coast, harbors, or the like, are bound to be continuously changed naturally or artificially, and such changes may directly or indirectly affect navigation. Thus, in order to ensure safe navigation or prevent marine accidents, an electronic navigational chart is supposed to quickly and accurately reflect such changes so as to be maintained up-to-date.

In general, in a mobile electronic navigational chart system, an electric navigational chart is periodically updated through an oceanographic research ship and oceanographic survey and observation device, and as the updating period and equipment are limited, it is impossible to change a far-reaching marine area in real time.

Also, when a danger such as a maritime work or construction, a farm, a mooring area of a vessel group, marine litter, and the like, is discovered, the electronic chart is changed based on a report from a seaman or a mariner, but a process thereof is so inconvenient that spontaneous participation of a seaman or a mariner is limited.

### SUMMARY OF THE INVENTION

The present invention has been made in an effort to provide a mobile terminal, an electronic navigational chart server, and a method for updating an electronic navigational chart based on crowdsourcing thereof having advantages of quickly and accurately updating an electronic navigational chart of a far-reaching marine area.

The present invention has also been made in an effort to provide a mobile terminal, an electronic navigational chart server, and a method for updating an electronic navigational chart based on crowdsourcing thereof having advantages of providing real-time navigation information allowing a vessel not having an electronic chart display and information system (ECDIS) or an electronic chart system (ECS) to safely sail navigate.

An exemplary embodiment of the present invention provides an electronic navigational chart server for updating an electronic navigational chart. The electronic navigational chart may include an electronic navigational chart database (DB), a transmission/reception unit, and an updating and visualizing unit. The electronic navigational chart DB may store an electronic navigational chart. The transmission/reception unit may receive navigational chart information regarding navigation collected from mobile terminals of a plurality of information providers embarked in a plurality of vessels. The updating and visualizing unit may update the electronic navigational chart by using the navigational chart received from the mobile terminals of the plurality of information providers.

The electronic navigational chart server may further include a verifying unit. The verifying unit may verify the navigational chart information received from the mobile terminals of the plurality of information providers before updating the electronic navigational chart.

The electronic navigational chart server may further include a data integrating unit. The data integrating unit may integrate the navigational chart information collected from the mobile terminals of the plurality of information providers, and provide at least one of navigation chart information of a corresponding location or an electronic navigational chart according to a request from a mobile terminal of an information requester.

The electronic navigational chart server may further include a user managing unit and a statistics and analyzing unit. The user managing unit may store and manage the navigational chart information collected from the mobile terminals of the plurality of information providers. The statistics and analyzing unit may compile statistics on the collected navigational chart information and analyze the same.

The electronic navigational chart server may further include a report data classifying unit. The report data classifying unit may classify a category of data to be received.

Another embodiment of the present invention provides a mobile terminal of a mariner embarked in a vessel for supporting updating of an electronic navigation chart. The mobile terminal may include a collecting unit and a transmission/reception unit. The collecting unit may collect navigation chart information regarding navigation from an internal sensor of the mobile terminal and an external sensor installed in the vessel. The transmission/reception unit may transmit the collected navigational chart information to an electronic navigational chart server. An electronic navigational chart may be updated by using the collected navigational chart information by the electronic navigational chart server.

The mobile terminal may further include a controller. The controller may classify the collected navigational chart information according to a category defined by the electronic navigational chart server before transmitting the navigational chart information.

The mobile terminal may further include a controller. The transmission/reception unit may receive navigational chart information regarding a current location from the electronic navigational chart server, and the controller may reflect the navigational chart information regarding the current location in the electronic navigational chart and control a screen output thereof.

The transmission/reception unit may receive the electronic navigational chart from the electronic navigational chart server, and the controller may store the received electronic navigational chart.

The mobile terminal may further include a social network service (SNS) providing unit. The SNS providing unit may exchange danger information determined on the basis of the navigational chart information with a social group of the mariner.

Yet another embodiment of the present invention provides a method for updating an electronic navigational chart in an electronic navigational chart updating system. The method may include: receiving, by an electronic navigational chart server, navigational information regarding navigation collected from mobile terminals of a plurality of information providers embarked in a plurality of vessels; updating, by the electronic navigational chart server, the electronic navigational chart by using the navigational chart information received from the mobile terminals of the plurality of information providers; and transmitting, by the electronic navigational chart server, at least one of the electronic navigational chart and the navigation chart information according to a request from a mobile terminal of an information requester.

The updating may include filtering and verifying the navigational chart information received from the mobile terminals of the plurality of information providers.

The method may further include defining, by the electronic navigational chart server, a category of information, wherein the receiving may include receiving navigational chart information classified according to the category by the mobile terminals of the plurality of information providers.

The method may further include receiving, by the electronic navigational chart server, information from at least one of a meteorological information system, an automatic identification system (AIS), a vessel traffic service (VTS), and a port traffic management system (PTMS), and the updating may include updating the electronic navigational chart by using the information received from the at least one of the above.

### BRIEF DESCRIPTION OF THE DRAWINGS

FIG. 1 is a view illustrating a system for updating an electronic navigational chart based on crowdsourcing according to an embodiment of the present invention.

FIG. 2 is a view illustrating a mobile terminal illustrated in FIG. 1.

FIG. 3 is a view illustrating an electronic navigational chart server illustrated in FIG. 1.

FIG. 4 is a flowchart illustrating a method for providing information in a mobile terminal according to an embodiment of the present invention.

FIGS. 5 and 6 are views illustrating an example of an output screen of the mobile terminal according to an embodiment of the present invention, respectively.

FIG. 7 is a flowchart illustrating a method for updating an electronic navigational chart in an electronic navigational chart server according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Hereinafter, a mobile terminal, an electronic navigational chart server, and a method for updating an electronic navigational chart based on crowdsourcing thereof will be described in detail with reference to the accompanying drawings.

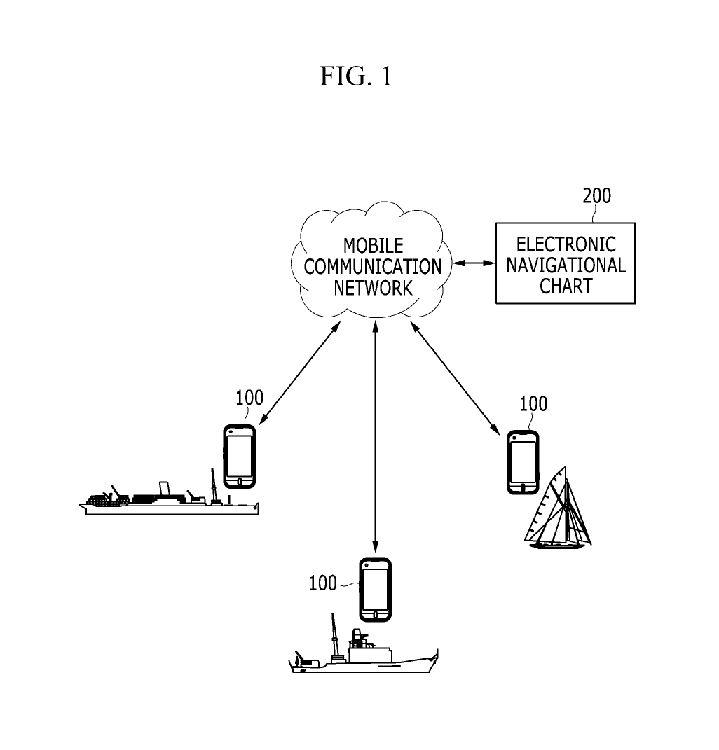

FIG. 1 is a view illustrating a system for updating an electronic navigational chart based on crowdsourcing according to an embodiment of the present invention.

Referring to FIG. 1, a system for updating an electronic navigational chart based on crowdsourcing according to an embodiment of the present invention includes a plurality of mobile terminals 100 and an electronic navigational chart server 200.

The mobile terminal 100 is a terminal carried by a person embarked on a small or medium vessel not equipped with an electronic chart display and information system (ECDIS) or an electronic chart system (ECS), such as a pleasure boat, a fishing boat, a yacht, a small vessel, a cruise ship, and the like, namely, a terminal held by a mariner, which is connected to the electronic navigational chart server 200 by using a mobile communication network.

The mobile terminal 100 provides navigational information in relation to navigation of a vessel to the electronic navigational chart server 200. Namely, the mariner terminal 100 provides information regarding a marine danger generated in real time, such as a marine construction or operation, a mesh, a farm, marine litter, and the like, generated in the vicinity of the coast and the harbor in real time, to the electronic navigational chart server 200. In this manner, the mariner providing navigational information is called an information provider.

The mobile terminal 100 may exchange information with neighboring mariners through the electronic navigational chart server 200.

The mobile terminal 100 may receive the latest electronic navigational chart from the electronic navigational chart server 200 and output the electronic navigational chart through a screen.

The electronic navigational chart server 200 receives navigational chart information regarding navigation of a vessel from the mobile terminal 100, continuously updates the electronic navigational chart by using the navigational chart information regarding navigation of a vessel received from the mobile terminal 100, and provides the latest navigation information to a mariner by using the updated electronic navigational chart.

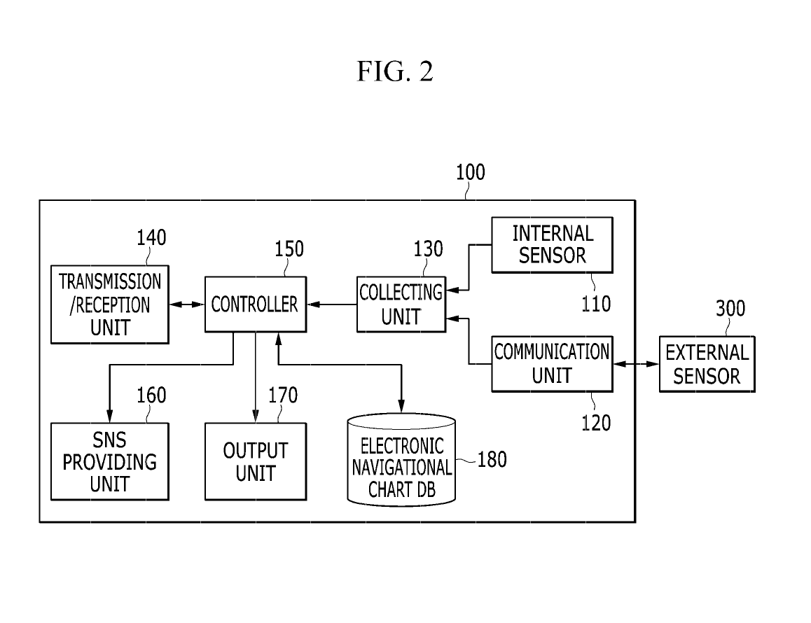

FIG. 2 is a view illustrating a mobile terminal illustrated in FIG. 1.

Referring to FIG. 2, the mobile terminal 100 includes an internal sensor 110, a communication unit 120, a collecting unit 130, a transmission/reception unit 140, a controller 150, a social network service (SNS) providing unit 160, an output unit 170, and an electronic navigational chart database (DB) (180). Here, at least some of the internal sensor 110, the communication unit 120, the collecting unit 130, the transmission/reception unit 140, the controller 150, the SNS providing unit 160, the output unit 170, and the electronic navigational chart DB 180 of the mobile terminal 100 may be implemented as hardware or as software, i.e., a program combined with hardware.

The internal sensor 110, a sensor installed in the mobile terminal 100, may include a GPS, a compass, a gyro sensor, a camera, and the like. Namely, the internal sensor 110 may provide a location of a vessel by a GPS, and may provide image data through a camera.

The communication unit 120 supports short-range communication with various external sensors 300 installed in a vessel. The external sensor 300 may be a sensor installed in a vessel.

The collecting unit 130 collects sensor data in real time from the external sensor 300 through the communication unit 120.

The transmission/reception unit 140 transmits sensor data collected through the internal sensor 110 and the external sensor 300 to the electronic navigational chart server 200. The transmission/reception unit 140 may receive a portion or the entirety of the electronic navigational chart from the electronic navigational chart server 200. Also, the transmission/reception unit 140 may request information from the electronic navigational chart server 200 or may receive requested information. The requested information may be an electronic navigational chart or navigational chart information corresponding to a current location in relation to navigation.

The controller 150 may classify the sensor data collected through the internal sensor 110 and the external sensor 300 according to determined categories, and report the same to the electronic navigational chart server 200 through the transmission reception unit 120. Here, the categorization may be determined by the electronic navigational chart server 200. For example, the sensor data may be categorized as “marine litter”, “under marine construction”, “farm”, or the like.

When the electronic navigational chart is received from the electronic navigational chart server 200 through the transmission/reception unit 140, the controller 150 stores the received electronic navigational chart in the electronic navigational chart DB 180.

The controller 150 requests navigational chart information corresponding to a current location from the electronic navigational chart electronic navigational chart server 200 through the transmission/reception unit 140, and when the information corresponding to the request is received from the electronic navigational chart server through the transmission/reception unit 140, the controller 150 provides control to reflect the received navigational chart information in the electronic navigational chart, and output the reflected electronic navigational chart. Here, the received information may include information verified by the electronic navigational chart server 200, and information not verified by the electronic navigational chart 200 as information provided from a different information provider.

The controller 150 may provide information regarding a navigational chart corresponding to the request from the mariner with reference to the electronic navigational chart.

Also, when there is information regarding danger in the vicinity on the basis of a location of a vessel, the controller 150 may output an alarm to allow a marine to recognize it.

The SNS providing unit 150 provides message exchange between information providers, as a social network service function. The SNS providing unit 150 may exchange information regarding danger in the vicinity on the basis of a location of a vessel with a registered social group. The social group refers to a group formed on the basis of a particular topic, a particular place, or a particular object in a social network.

The output unit 170 may output an electronic navigational chart to a screen under the control of the controller 150.

The SNS providing unit provides message exchange between information providers, as an SNS function.

The electronic navigational chart DB 190 stores the electronic navigational chart received from the electronic navigational chart server 200.

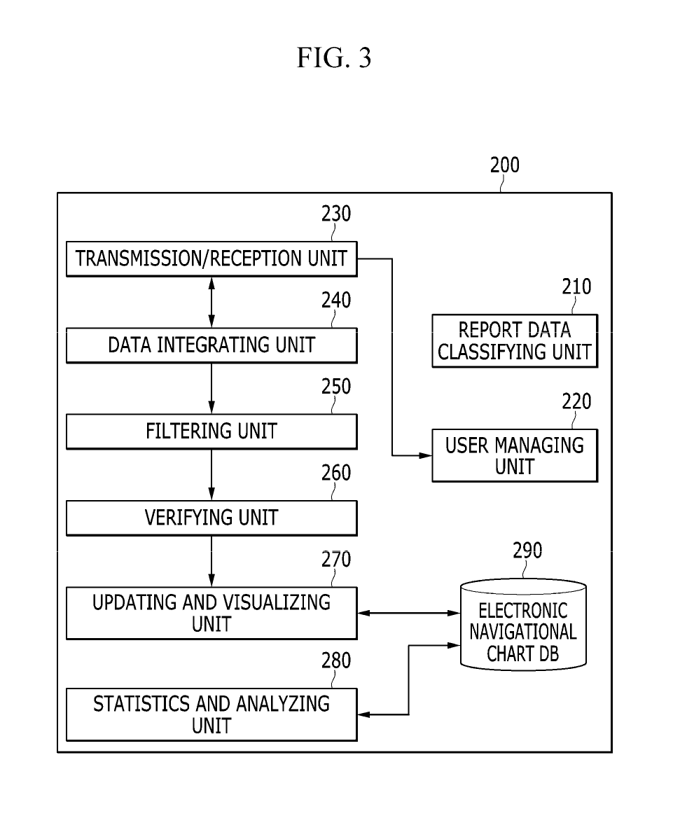

FIG. 3 is a view illustrating an electronic navigational chart server illustrated in FIG. 1.

Referring to FIG. 3, the electronic navigational chart server 200 includes a report data classifying unit 210, a user managing unit 220, a transmission/reception unit 230, a data integrating unit 240, a filtering unit 250, a verifying unit 260, an updating and visualizing unit, a statistics and analyzing unit 280, and an electronic navigational chart DB 290.

The report data classifying unit 210 defines categories of report data to be collected through crowdsourcing, and classifies them. Then, the mobile terminal 100 providing information classifies collected data according to category, and provides the same to the electronic navigational chart server 200.

The user managing unit 220 manages information regarding an information provider. The user managing unit 220 stores and manages navigation chart information received from the information provider.

The transmission/reception unit 230 transmits and receives information to and from the mobile terminal 100.

The data integrating unit 240 integrates data collected from the mobile terminal 100 of the information provider. When the data integrating unit 240 receives a request for navigational chart information from the mobile terminal 100, it provides corresponding navigational chart information to the mobile terminal 100 through the transmission/reception unit 230.

The filtering unit 250 filters the data collected from the mobile terminal 100 of the information provider.

The verifying unit 260 verifies the data collected from the mobile terminal 100 of the information provider, before the data is reflected in the electronic navigational chart as original data. Here, the verifying may be performed by a manager of the electronic navigational chart server 200 through direct confirmation on the spot, or may be performed by collectively evaluating data received from a plurality of different mobile terminals with respect to the same location and place. Namely, the verifying unit 260 may verify the corresponding data by collectively evaluating data regarding the same location and place received from a plurality of mobile terminals.

The updating and visualizing unit 270 updates the electronic navigational chart by reflecting the verified data therein, and visualizes the updated electronic navigational chart. The updating and visualizing unit 270 stores the updated electronic navigational chart in the DB 290.

Also, the updating and visualizing unit 270 may receive information from external systems such as a meteorological information system 400, an automatic identification system (AIS) 500, a vessel traffic service (VTS) 600, a port traffic management system (PTMS) 700, and the like.

The filtering unit 250, the verifying unit 260, and the updating and visualizing unit 270 may perform a filtering, verifying, and updating operation according to an instruction from a manager of the electronic navigational chart server 200, respectively, and may perform the filtering, verifying, and updating operation according to a determined period, respectively.

The statistics and analyzing unit 280 provides statistics and analysis according to a user or a location/time with respect to the collected data.

The electronic navigational chart DB 290 stores the electronic navigational chart updated by the updating and visualizing unit 270.

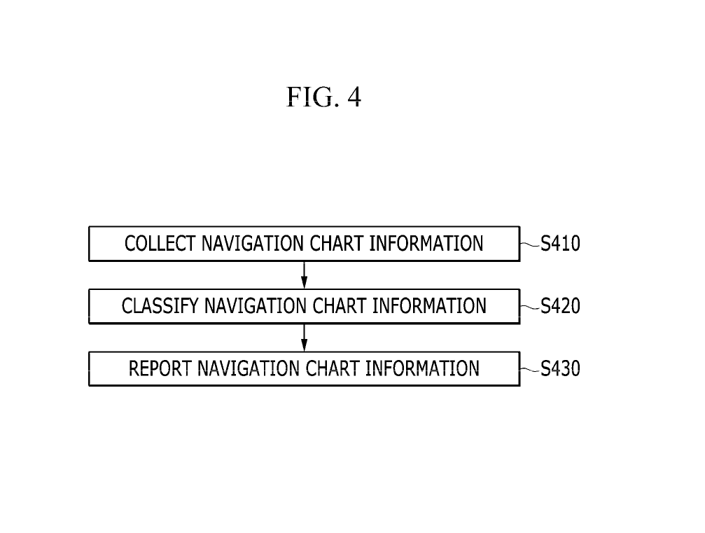

FIG. 4 is a flowchart illustrating a method for providing information in a mobile terminal according to an embodiment of the present invention.

Referring to FIG. 4, the mobile terminal 100 is a terminal held by a mariner embarked on a vessel under sail. While the vessel is navigating, the mobile terminal 100 collects navigational chart information regarding navigation through the internal sensor 110 and the external sensor 300 (S410).

The mobile terminal classifies the collected navigational chart information according to a category (S420), and reports the navigational chart information classified according to a category to the electronic navigational chart server 200 (S430).

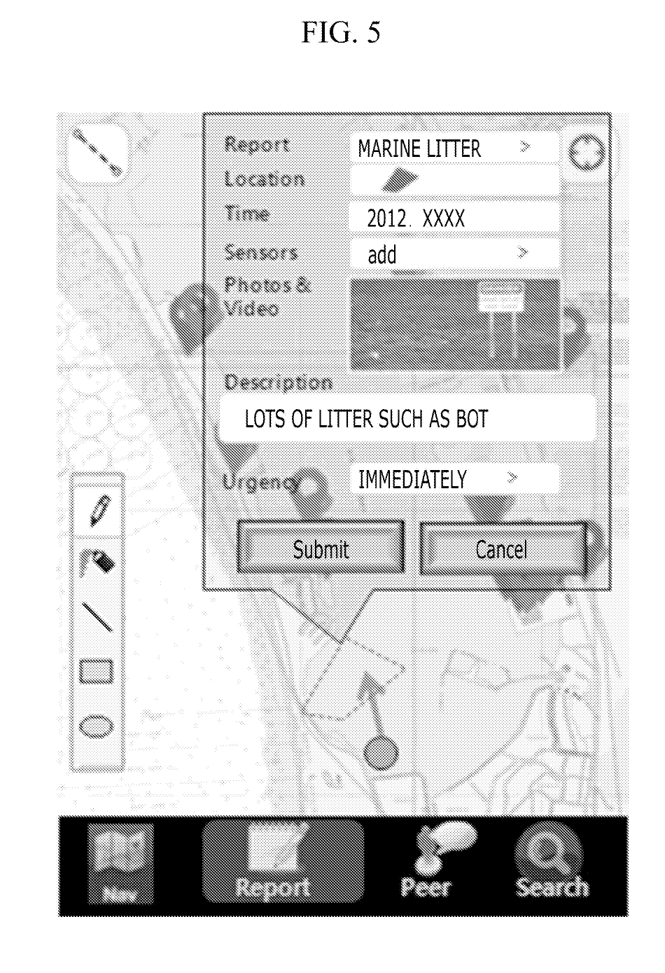

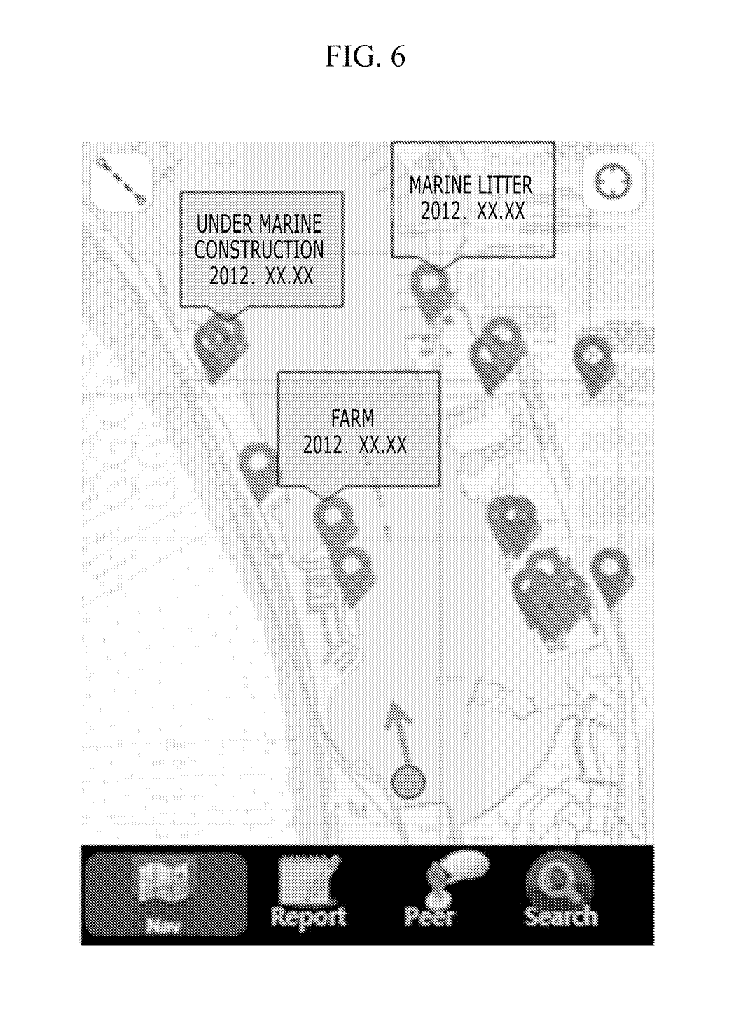

FIG. 5 is a view illustrating a screen displaying reported information, as an example of an output screen of the mobile terminal according to an embodiment of the present invention, and FIG. 6 is a view illustrating an electronic navigational chart reflecting collected information, as an example of an output screen of the mobile terminal according to an embodiment of the present invention.

For example, in a case in which a certain location in the ocean is contaminated with marine litter, a mariner may capture an image of the marine litter through a camera of the mobile terminal 100 or may generate information indicating the generation of marine litter.

As illustrated in FIG. 5, the mobile terminal 100 may classify the captured image of or the information regarding the marine litter as a category of marine litter, create a location, a time, and additional comment, or the like, and report the same to the electronic navigational chart server 200.

Also, the mobile terminal 100 may reflect the collected information in the electronic navigational chart stored in the mobile terminal 100, and the electronic navigational chart reflecting the collected information is output through a screen of the mobile terminal 100 as illustrated in FIG. 6. Namely, information such as “marine litter”, “under sea construction”, and “farm” may be displayed on the electronic navigational chart in an overlap manner by the collected information.

In the output screens of FIGS. 5 and 6, “Report” indicates a report function, and “Peer” indicates an SNS function. Also, “Search” indicates a search function.

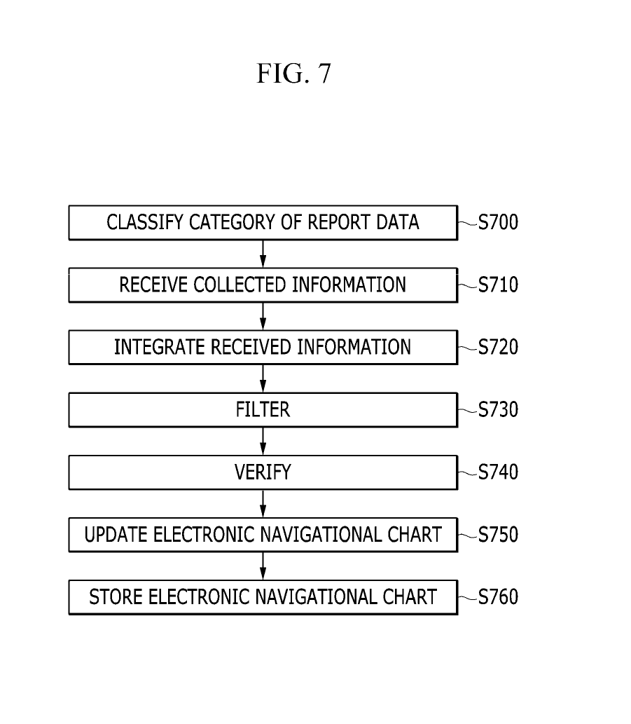

FIG. 7 is a flowchart illustrating a method for updating an electronic navigational chart in an electronic navigational chart server according to an embodiment of the present invention.

Referring to FIG. 7, the electronic navigational chart server 200 classifies categories of report data to be collected through crowdsourcing (S700).

The electronic navigational chart server 200 receives the collected information from the mobile terminals 100 of a plurality of information providers (S710).

The electronic navigational chart server 200 integrates the information received from the mobile terminals 100 of a plurality of information providers (S720).

The electronic navigational chart server 200 filters the information received from the mobile terminals 100 of a plurality of information providers (S730), and verifies the same (S740).

The electronic navigational chart server 200 updates the electronic navigational chart by reflecting the verified information in the electronic navigational chart (S750).

The electronic navigational chart server 200 designates the updated electronic navigational chart in the electronic navigational chart DB 290 (S760). In this manner, the electronic navigational chart server 200 according to an embodiment of the present invention updates the electronic navigational chart through participation of the information providers.

When there is a request for the electronic navigational chart from the mobile terminal 100, the electronic navigational chart server 200 provides a portion or the entirety of the electronic navigational chart stored in the electronic navigational chart DB 290 to the mobile terminal 100.

According to an embodiment of the present invention, real-time navigation information can be provided to allow a small vessel, a cruise ship, a motor boat, a yacht, or the like, without an electronic chart display and information system (ECDIS) or an electronic chart system (ECS), to safely navigate.

In addition, since an electronic navigational chart is updated through spontaneous participation of numerous mariners running small vessels, rather than through a limited number of oceanographic research ships or equipment, the electronic navigational chart can be updated more quickly and accurately in a far-reaching area as the number of participants increases, relative to an existing updating method, and safe navigation can be ensured and marine accidents can be prevented.

The embodiments of the present invention may not necessarily be implemented only through the foregoing devices and/or methods, but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electronic navigational chart server for updating an electronic navigational chart, comprising:
an electronic navigational chart DB configured to store an electronic navigational chart;
a transmission/reception unit configured to receive navigational chart information regarding navigation collected from mobile terminals of a plurality of information providers embarked in a plurality of vessels; and
an updating and visualizing unit configured to update the electronic navigational chart by using the navigational chart received from the mobile terminals of the plurality of information providers.

2. The electronic navigational chart server of claim 1, further comprising
a verifying unit configured to verify the navigational chart information received from the mobile terminals of the plurality of information providers before updating the electronic navigational chart.

3. The electronic navigational chart server of claim 1, further comprising
a data integrating unit configured to integrate the navigational chart information collected from the mobile terminals of the plurality of information providers, and provide at least one of navigation chart information of a corresponding location or an electronic navigational chart according to a request from a mobile terminal of an information requester.

4. The electronic navigational chart server of claim 1, further comprising:
a user managing unit configured to store and manage the navigational chart information collected from the mobile terminals of the plurality of information providers; and
a statistics and analyzing unit configured to compile statistics on the collected navigational chart information and analyze the same.

5. The electronic navigational chart server of claim 1, further comprising
a report data classifying unit configured to classify a category of data to be received.

6. A mobile terminal of a mariner embarked in a vessel for supporting updating of an electronic navigation chart, the mobile terminal comprising:
a collecting unit configured to collect navigation chart information regarding navigation from an internal sensor of the mobile terminal and an external sensor installed in the vessel; and
a transmission/reception unit configured to transmit the collected navigational chart information to an electronic navigational chart server,
wherein an electronic navigational chart is updated by using the collected navigational chart information by the electronic navigational chart server.

7. The mobile terminal of claim 6, further comprising
a controller configured to classify the collected navigational chart information according to a category defined by the electronic navigational chart server before transmitting the navigational chart information.

8. The mobile terminal of claim 6, wherein the transmission/reception unit receives navigational chart information regarding a current location from the electronic navigational chart server, and
the mobile terminal further comprises
a controller configured to reflect the navigational chart information regarding the current location in the electronic navigational chart and control a screen output thereof.

9. The mobile terminal of claim 8, wherein the transmission/reception unit receives the electronic navigational chart from the electronic navigational chart server, and the controller stores the received electronic navigational chart.

10. The mobile terminal of claim 6, further comprising
a social network service (SNS) providing unit configured to exchange danger information determined on the basis of the navigational chart information with a social group of the mariner.

11. A method for updating an electronic navigational chart in an electronic navigational chart updating system, the method comprising:
receiving, by an electronic navigational chart server, navigational information regarding navigation collected from mobile terminals of a plurality of information providers embarked in a plurality of vessels;
updating, by the electronic navigational chart server, the electronic navigational chart by using the navigational chart information received from the mobile terminals of the plurality of information providers; and
transmitting, by the electronic navigational chart server, at least one of the electronic navigational chart and the navigation chart information according to a request from a mobile terminal of an information requester.

12. The method of claim 11, wherein the updating comprises
filtering and verifying the navigational chart information received from the mobile terminals of the plurality of information providers.

13. The method of claim 11, further comprising
defining, by the electronic navigational chart server, a category of information,
wherein the receiving comprises receiving navigational chart information classified according to the category by the mobile terminals of the plurality of information providers.

14. The method of claim 11, further comprising
receiving, by the electronic navigational chart server, information from at least one of a meteorological information system, an automatic identification system (AIS), a vessel traffic management system, and a coast management system, and
the updating comprises updating the electronic navigational chart by using the information received from the at least one of the above.
